(19) United States
(12) Patent Application Publication
(10) Pub. No.: US 2018/0300896 A1
(43) Pub. Date: Oct. 18, 2018

(54) DETERMINING THE ORIENTATION OF IMAGE DATA BASED ON USER FACIAL POSITION

(71) Applicant: MOTOROLA MOBILITY LLC, Chicago, IL (US)

(72) Inventor: Liang ZHANG, Beijing (CN)

(21) Appl. No.: 15/566,505

(22) PCT Filed: Jun. 3, 2015
(86) PCT No.: PCT/CN2015/080714

§ 371 Date: Oct. 13, 2017

(51) Int. Cl. G06T 7/73; G06F 3/01; H04N 5/232; G06K 9/00; G06T 7/12

(52) U.S. Cl. CPC G06T 7/74; G06F 3/012; G06F 3/013; G06T 2207/30201; G06K 9/00248; G06T 7/12; H04N 5/23219

(57) ABSTRACT

A method for determining an orientation of m image includes generating first image data using a device, determining a user facial orientation, relative to the device, determining an orientation parameter based on the determined user facial orientation, and storing a first data file including the first image data and the determined orientation parameter. A device includes a easing having: first and second opposing surfaces, a first camera disposed on the first surface, a second camera disposed on the second surface, and a processor. The processor is to generate first image data using the first camera, generate second image data using the second camera, determine a user facial orientation based on the second image data, determining an orientation parameter for die first image data based on the user facial orientation, and store a first data file including the first Image data and the orientation parameter.

### FIELD OF THE DISCLOSURE

The disclosed subject matter relates generally to computing systems and, more particularly, to determining the orientation of image data based on user facial position.

### BACKGROUND OF THE DISCLOSURE

Handheld computing devices, such as mobile phones and tablets typically control the orientation of the data displayed on a screen of the device based upon how a user is holding the device. An orientation sensor in the device measures the position of the device relative to the earth and changes the display orientation in response to the user rotating the device. In general, the orientation sensor may be implemented using a virtual sensor that receives information from a physical sensor (e.g., accelerometer data) and uses that information to determine the position of the device. The orientation sensor typically determines the position of the device in a plane essentially perpendicular to the earth's surface (i.e., a vertical plane). Consider a mobile device having a generally rectangular shape with long and short axes. If the user is holding the device such that the long axis is generally perpendicular to the earth, the display orientation is set to portrait mode. If the user rotates the device such that the long axis is orientated generally parallel to the earth (i.e., holds the device sideways), the orientation sensor detects the changed position and automatically changes the display orientation so that the data is displayed in landscape mode. This process is commonly referred to as auto-rotate mode.

When a user uses the device in a camera mode, the default orientation of the image data (picture or video) is assumed to be the same orientation as the device. However, in many cases, when attempting to use the device in camera mode, the device is held in non-standard positions. For example, the user may hold the device in a position above the subject of the picture and looking downward. The accuracy of the auto-rotate mode for determining the actual orientation of the device depends on how the device is being held by the user. Because the earth is used as a reference, the orientation is determined in a plane essentially perpendicular to the earth. If the user holds the device in a plane that is substantially parallel to the earth, the orientation sensor has difficulty determining the orientation or sensing changes in the orientation. As a result, the assumed orientation for the picture may be incorrect.

The present disclosure is directed to various methods and devices that may solve or at least reduce some of the problems identified above.

### BRIEF DESCRIPTION OF THE DRAWINGS

The disclosure may be understood by reference to the following description taken in conjunction with the accompanying drawings, in which like reference numerals identify like elements, and in which:

FIG. 1 is a simplified block diagram of a device including a computing system configured to determine the orientation of a picture based on user facial position, according, to some embodiments.

FIGS. 2 and 3 are flow diagrams of methods for determining the orientation of image data based on user facial position, according to some embodiments; and

FIGS. 4-6 are diagrams of the device of FIG. 1 illustrating how the orientation of the image data may be determined based on how the user positions and views the device when capturing image data, according to some embodiments.

While the subject matter disclosed herein is susceptible to various modifications and alternative forms, specific embodiments thereof have been shown by way of example in the drawings and are herein described in detail. It should be understood, however, that the description herein of specific embodiments is not intended to be limiting, but on the contrary, the intention is to cover all modifications, equivalents, and alternatives falling within the scope of the invention as defined by the appended claims.

### DETAILED DESCRIPTION

Various illustrative embodiments of the disclosure are described below. In the interest of clarity, not all features of an actual implementation are described in this specification. It will of course be appreciated that in the development of any such actual embodiment, numerous implementation-specific decisions must be made to achieve the developers specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present subject matter will now be described with reference to the attached figures. Various structures, systems and devices are schematically depicted in the drawings for purposes of explanation only and so as to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term of phrase is intended to have a special meaning. i.e., a meaning other than that understood by skilled artisans, such a special definition will be expressly set forth in the specification in a definitional manner that directly and unequivocally provides the special definition for the term or phrase.

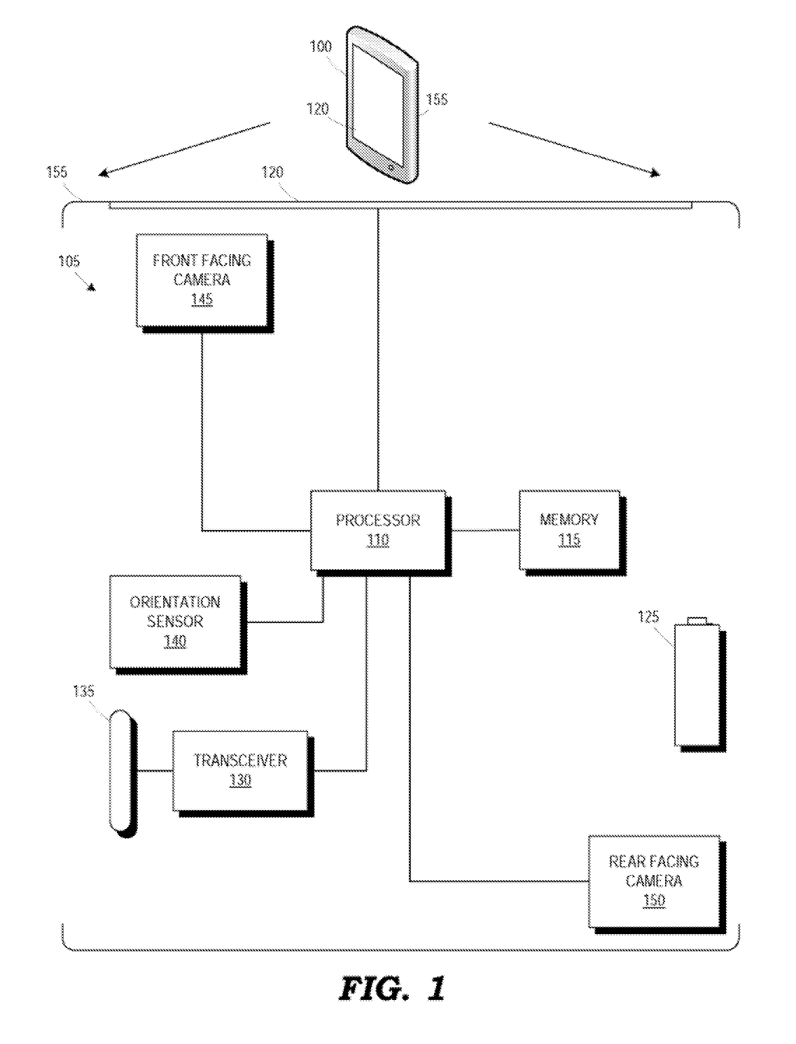

FIGS. 1-6 illustrate example techniques for determining the orientation of image data based on user facial position. Employing user facial position to determine the orientation of the image data increases the accuracy of the orientation determination as compared to using the determined orientation of the device, especially when the device is being held in a plane parallel to the Earth, thereby resulting in greater user satisfaction.

FIG. 1 is a block diagram of a device 100 including a computing system 105. The computing system 105 includes a processor 110, a memory 115, a display 120, and a battery 125 to provide power for the computing system 105. The memory 115 may be a volatile memory (e.g., DRAM, SRAM), a non-volatile memory (e.g., ROM, flash memory, etc.), or some combination thereof. In some embodiments, the device 100 may be a communications device, such as a mobile phone, and the computing system may include a transceiver 130 for transmitting and receiving signals via an antenna 135. The transceiver 130 may include multiple radios for communicating according to different radio access technologies, such as Wi-Fi or cellular. An orientation sensor 140 (e.g., an accelerometer, magnetometer, mercury switch, gyroscope, compass, or some combination thereof) may be provided to measure the position of the device 100 relative to a physical reference point or surface. The orientation sensor 140 may be a physical sensor or a virtual sensor that receives data from a physical sensor and processes that data to determine the position of the device 100. The device 100 includes a front facing camera 145 disposed on the same surface of the device 100 as the display 120 and a rear facing camera 150 disposed on an opposite surface of the device 100. The device 100 includes an outer casing 155 that supports the display 120 and surrounds the active components of the computing system 105 and provides outer surfaces along which a user interfaces with the device 100.

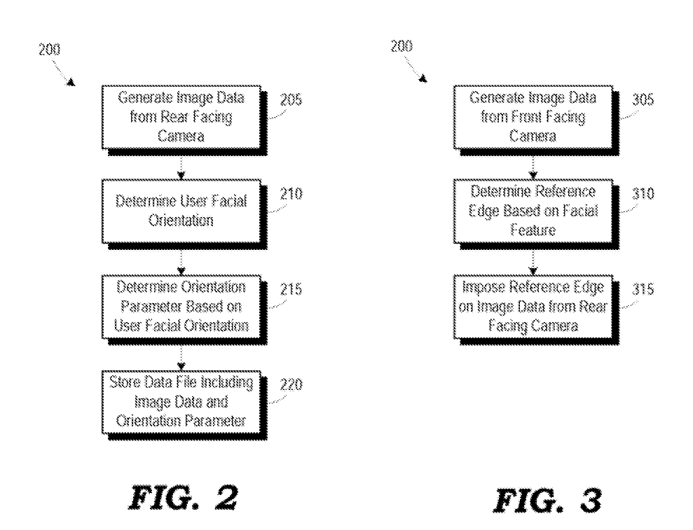

The processor 110 may execute instructions stored in the memory 115 and store information in the memory 115, such as the results of the executed instructions. The processor 110 controls the display 120 and may receive user input from the display 120 for embodiments where the display 120 is a touch screen. Some embodiments of the processor 110, the memory 115, and the cameras 145, 150 may be configured to perform portions of the method 200 shown in FIG. 2. For example, the processor 110 may execute an application that may be a portion of the operating system for the computing system 105 to determine the orientation of image data collected using one of the cameras 145, 150. Although a single processor 110 illustrated, in some embodiments, the processor 110 may include multiple distributed processors.

In various embodiments, the device 100 may be embodied in handheld or wearable device, such as a laptop computer, a handheld computer, a tablet computer, a mobile device, a telephone, a personal data assistant (“PDA”), a music player, a game device, a device attached to a user (e.g., a smart watch or glasses), and the like. To the extent certain example aspects of the device 100 are not described herein, such example aspects may or may not be included in various embodiments without limiting the spirit and scope of the embodiments of the present application as would be understood by one of skill in the art.

FIG. 2 is a flow diagram of an illustrative method 200 for determining the orientation of image data based on user facial position, in accordance with some embodiments. In method block 205, image data is generated using the rear facing camera 150. For example, the rear facing camera 150 in the device 100 may be employed to collect still image data or video data, referred to generically as image data. In method block 210, a user facial orientation relative to the device 100 is determined. An exemplary technique for identifying the user facial orientation using image data collected from the front facing camera 145 is described in greater detail below in reference to FIGS. 3-5. In method block 215, an orientation parameter is determined based on the user facial orientation. The orientation parameter generally identifies the orientation of the image data. In one embodiment, if the image data is a grid of data arranged in rows and columns, the orientation parameter specifies the orientation of the rows and columns. In a specific example, the positions in the grid corresponding to row “0” and column “0” may be specified by the orientation parameter (e.g., both the row “0” and column “0” identifiers can be selected from the top, bottom, left, or right side edges of the image data grid). In another embodiment, the orientation parameter may specify an amount of rotation associated with a reference position in the grid of image data. In method block 220, a data file including the image data and the determined orientation parameter is stored. In some embodiments, the determined orientation parameter may specify the top edge of the image data so that when the image data is subsequently displayed (i.e., on the device 100 or on another device), the orientation of the image data is correct relative to the user facial orientation when the image data was collected.

FIG. 3 is a flow diagram of an illustrative method 300 for determining the user facial orientation, in accordance with some embodiments. In method block 305, image data is generated using the front facing camera 145. This image data may include an image of the user, since the user typically views the display 120 when initiating the generation of the image data from the rear facing camera 50 (see method block 205). The collection of the image data from the front facing camera 145 may occur responsive to the user activating the camera by interfacing with the display 120 or by the user activating another button on the device 100 to collect the image data using the rear facing camera 150. The collection of the image data from both cameras 145, 150 may occur at the same time or sequentially. For example, the cameras 145, 150 and the processor 110 may support concurrent image data collection. Otherwise, the image data for the desired image may be collected using the rear facing camera 150, and as soon as the processor 110 is available, the data may be collected from the front facing camera 145.

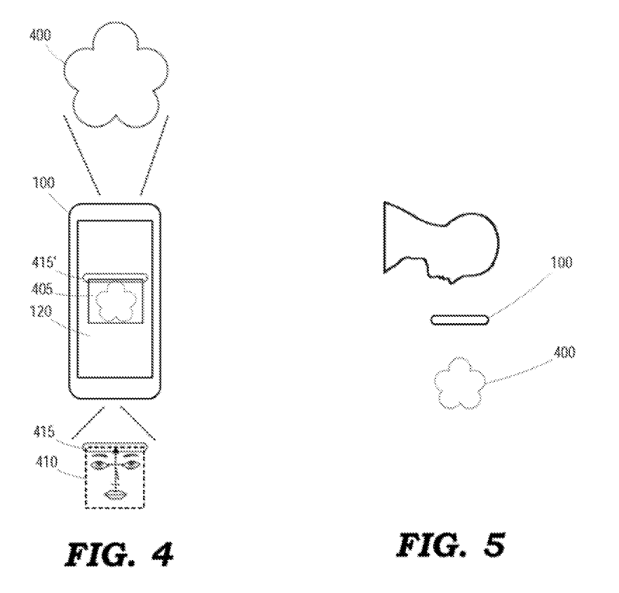

FIGS. 4 and 5 illustrates a diagram of the device 100 as it may be employed to capture image data. The rear facing camera 145 is directed at a subject 400. In the illustrated example, the device 100 is being held in a plane that is generally parallel to the Earth, such that the orientation sensor 140 has difficulty determining the position of the device 100 relative to the user. Although the subject 400 is illustrated as being in front of the device 100 in FIG. 4, it is actually disposed below the device 100, as illustrated in the side view of FIG. 5. When the user activates the camera 150, first image data 405 is collected and possibly displayed on the display 120. Second image data 410 is collected using the rear facing camera 145 at the same time as or shortly after collecting the first image data 405.

The second image data 410 includes an image of the user that was viewing the display 120 when the first image data 405 was collected. Generally, the second image data 410 is temporary data that is not saved or displayed. Returning to FIG. 3, the processor 110 evaluates the second image data to determine a reference edge 415 in method block 310. In one example, the reference edge identifies the “top” edge of the second image data 410 using a facial feature identification technique. Of course, other references such as the bottom or side edges of the display may also be used if desired. Various techniques for recognizing facial features in image data are known in the art and are not described in detail herein. In general, the eyes, nose, eyebrows, or some combination thereof may be used to determine the presence of a face and its orientation relative to the display 120. For example, image recognition may be used to identify the eyes. A line extending between the eyes defines a horizontal reference relative to the user. The eyebrows or nose may also be detected to allow a vertical reference line perpendicular to the horizontal reference line to be drawn. The “top” edge is determined he the edge that is intersected by the vertical line in a direction from the eyes toward the eyebrows or in a direction from the nose toward the eyes. The edge intersected by the vertical reference line is designated as the reference edge 415.

In method block 315, the processor 110 imposes the reference edge 415 on the first image data 405 taken using the rear facing camera 150, designated as reference edge 415′. The orientation parameter determined in method block 215 identities the reference edge 415′ as the top edge of the second image data 405.

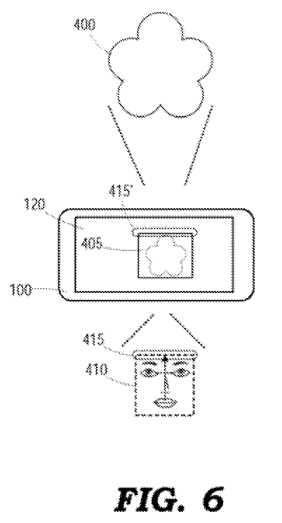

FIG. 6 illustrates the device 100 as it may be held in a different position. Because the reference edge 415 is identified using the second image data 410 based on the facial orientation of the user and then imposed on the first image data 405 as the reference edge 415′, the “top” edge can still be readily identified.

Employing user facial orientation data when determining the orientation of image data increases the accuracy of the determination and mitigates the problems associated with accurate position determination arising from the plane in which the device 100 is being held.

In some embodiments, certain aspects of the techniques described above may implemented by one or more processors of a processing system executing software. The methods 200, 300 described herein may be implemented by executing software on a computing device, such as the processor 110 of FIG. 1, however, such methods are not abstract in that they improve the operation of the device 100 and the user's experience when operating the device 100. Prior to execution, the software instructions may be transferred from the non-transitory computer readable storage medium to a memory, such as the memory 115 of FIG. 1.

The software may include one or more sets of executable instructions stored or otherwise tangibly embodied on a non-transitory computer readable storage medium. The software can include the instructions and certain data that, when executed by one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), nonvolatile memory (e.g., read-only memory ROM) of Flash memory), or microeloctromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

A method for determining an orientation of an image includes generating first image data using a device, determining a user facial orientation relative to the devices determining an orientation parameter based on the determined user facial orientation, and storing a first data file including the first image data and the determined orientation parameter.

A device includes a casing having first and second opposing surfaces, a first camera disposed on the first surface, a second camera disposed on the second surface, and a processor. The processor is to generate first image data using the first camera, generate second image data using the second camera, determine a user facial orientation based on the second image data, determining an orientation parameter for the first image data based on the user facial orientation, and store a first data file including the first image data and the orientation parameter.

The particular embodiments disclosed above are illustrative only, and may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope of the disclosure. Note that the use of terms, such as “first,” “second,” “third” or “fourth” to describe various processes or structures in this specification and in the attached claims is only used as a shorthand reference to such steps/structures and does not necessarily imply that such steps/structures are performed/formed in that ordered sequence. Of course, depending upon the exact claim language, an ordered sequence of such processes may or may not be required. Accordingly, the protection sought herein is as set forth in the claims below.

What is claimed:

1. A method for determining an orientation of an image, comprising:
generating first image data using a device;
determining a user facial orientation relative to the device;
determining an orientation parameter based on the determined user facial orientation; and
storing a first data file including the first image data and the determined orientation parameter.

2. The method of claim 1, wherein the device comprises a first camera positioned on a first surface of the device and a second camera positioned on a second surface of the device other than the first surface, and the method further comprises:
generating the first image data using the first camera;
generating second image data using the second camera; and
determining the user facial orientation based on the second image data.

3. The method of claim 2, wherein determining the user facial orientation comprises identifying a facial feature in the second image data.

4. The method of claim 3, wherein identifying the facial feature comprises identifying at least one of an eye orientation, a nose orientation, or an eyebrow orientation.

5. The method of claim 3, wherein determining the use facial orientation comprises:
identifying a first edge in the second image data based on the facial feature; and
determining a second edge in the first image data corresponding to the first edge,
wherein the orientation parameter identifies the second edge.

6. The method of claim 5, wherein the first edge comprises a first top edge of the second image data, and the second edge comprises a second top edge of the first image data.

7. The method of claim 1, wherein the orientation parameter identifies a top edge of the first image data.

8. The method of claim 1, wherein the first image data comprises still image data.

9. The method of claim 1, wherein the first image data comprises video data.

10. A method for determining an orientation of an image, comprising:
generating first image data using a first camera in a device;
generating second image data using a second camera in the device responsive to generating the first image data;
identifying a reference edge in the second image data, the reference edge indicating an orientation of the second image data; and
determining an orientation parameter for the first image data based on the reference edge; and
storing a first data file including the first image data and the orientation parameter.

11. The method of claim 10, further comprising identifying a top edge in the first image data corresponding to the reference edge.

12. The method of claim 11, wherein the orientation parameter identifies the top edge in the first image data.

13. A device, comprising:
a casing having first and second opposing surfaces;
a first camera disposed on the first surface;
a second camera disposed on the second surface; and
a processor to generate first image data sing the first camera, generate second image data using the second camera, determine a user facial orientation based on the second image data, determining an orientation parameter for the first image data based on the user facial orientation; and store a first data file including the first image data and the orientation parameter.

14. The device of claim 13, wherein the processor is to determine the user facial orientation by identifying a facial feature in the second image data.

15. The device of claim 14, wherein the facial feature comprises at least one of an eye feature, a nose feature, or an eyebrow feature.

16. The device of claim 14, wherein the processor is to determine the user facial orientation by identifying a first edge in the second image data based on the facial feature and determining a second edge in the first image data corresponding to the first edge, wherein the orientation parameter identities the second edge.

17. The device of claim 16, wherein the first edge comprises a first top edge of the second image data, and the second edge comprises a second top edge of the first image data.

18. The device of claim 13, wherein the orientation parameter identifies a top edge of the first image data.

19. The device of claim 13, wherein the first image data comprises still image data.

20. The device of claim 13, wherein the first image data comprises video data.
